(19) United States
(12) Patent Application Publication
(10) Pub. No.: US 2021/0053254 A1
(43) Pub. Date: Feb. 25, 2021

(54) BONDING MATERIAL, METHOD FOR PRODUCING THE SAME, FIBER MOLDED PRODUCT, AND METHOD FOR PRODUCING THE SAME

(71) Applicant: SEIKO EPSON CORPORATION, Tokyo (JP)

(72) Inventor: Yoshihiro UENO, Shiojiri (JP)

(21) Appl. No.: 16/997,998

(22) Filed: Aug. 20, 2020

(30) Foreign Application Priority Data
Aug. 22, 2019 (JP) 2019-151892

(51) Int. Cl. B29B 9/02; B29B 7/04; B29B 9/12

(52) U.S. Cl. CPC B29B 9/02; B29K 2067/00; B29B 9/12; B29B 7/04

(57) ABSTRACT

A method for producing a bonding material includes a kneading step of melting and kneading a polyester resin and a terpene resin to prepare a resin composition and a crushing step of crushing the resin composition.

The present application is based on, and claims priority from JP Application Serial Number 2019-151892, filed Aug. 22, 2019, the disclosure of which is hereby incorporated by reference herein in its entirety.

### BACKGROUND

### 1. Technical Field

The present disclosure relates to a bonding material, a method for producing a bonding material, a fiber molded product, and a method for producing a fiber molded product.

### 2. Related Art

Fiber molded products such as paper are required to have various mechanical properties depending on their applications. For example, JP-A-2007-084982 discloses a technique for improving the tear strength of paper, in which a process paper obtained by covering both surfaces of a base paper, mainly containing natural pulp, with polyolefin-based resin is provided by defining the weighted average fiber length of pulp fibers constituting the base paper and drying wet paper in a pressurized drying step. Also, as a method for producing fiber molded products such as paper, a dry process, which uses little or no water, has been anticipated in recent years.

Fiber molded products produced by the dry process also need to satisfy many mechanical properties. Among various mechanical properties, tear strength generally needs to be increased in many cases, regardless of the production method such as a dry process or a wet process. There is need for a bonding material capable of improving the tear strength of fiber molded products produced by a dry process, a method for producing the bonding material, a fiber molded product including the bonding material, and a method for producing the fiber molded product.

### SUMMARY

An aspect of a method for producing a bonding material according to the present disclosure is a method for producing a bonding material, including

a kneading step of melting and kneading a polyester resin and a terpene resin to prepare a resin composition and

a crushing step of crushing the resin composition.

In the above-described aspect of the method,

the kneading step may include performing the melting and the kneading such that a content of the terpene resin relative to a total amount of the resin composition is 5% by mass or more and 10% by mass or less.

In the above-described aspect of the method, the crushing step may include crushing the resin composition so as to have a volume average particle size of 1 μm or more and 50 μm or less.

The above-described aspect of the method may further include,

a classification step of classifying the bonding material so that a volume average particle size of the bonding material is 5 μm or more and 23 μm or less.

An aspect of a bonding material according to the present disclosure includes

a resin composition containing a polyester resin and a terpene resin.

In the above-described aspect of the bonding material,

a content of the terpene resin relative to a total amount of the resin composition may be 5% by mass or more and 10% by mass or less.

In the above-described aspect of the bonding material,

the bonding material may be powder and have a volume average particle size of 5 μm or more and 23 μm or less.

An aspect of a fiber molded product according to the present disclosure includes

the above-described aspect of the bonding material and a plurality of fibers, in which

the plurality of fibers is bound by the bonding material.

An aspect of a method for producing a fiber molded product according to the present disclosure includes

a mixing step of mixing the above-described aspect of the bonding material and fibers,

an accumulation step of accumulating the fibers and the bonding material mixed together, and

a binding step of binding the fibers and the bonding material of the accumulated product.

### DESCRIPTION OF EXEMPLARY EMBODIMENTS

Hereinafter, embodiments of the present disclosure will be described. The embodiments described below are for explaining examples of the present disclosure. The present disclosure is not limited to the following embodiments in any way and encompasses variations which are realized within a scope that does not change the gist of the present disclosure. It is noted that not all the structures described below are necessarily essential structures of the present disclosure.

### 1. Bonding Material

The bonding material according to the present embodiments is constituted by a resin composition including a polyester resin and a terpene resin.

### 1.1. Resin Composition

The resin composition constituting the bonding material includes a polyester resin and a terpene resin.

### 1.1.1. Polyester Resin

Polyester resins plasticize and melt when heated. When the temperature of a polyester resin increases, fluidity occurs. Melted polyester resins solidify when cooled. Polyester resins have a function of binding fibers.

An example of a polyester resin is a macromolecule that is obtained by polymerizing a diol and dicarboxylic acid and that has an ester bond in the main chain. Examples of a pure polyester resin include polyethylene terephthalate and polybutylene terephthalate. Also, polyester resins may be copolymerized or modified, or various groups may be introduced to the main chain or side chain of a polyester resin by copolymerization or modification.

The polyester resin is miscible with the terpene resin. Multiple polyester resins may be used. However, in this case, a polyester resin miscible with at least one of the later-described terpene resins is selected as at least one of the polyester resins.

From the viewpoint of good compatibility and bonding properties with the later-described fiber, among polyester resins, a particularly preferable polyester resin is a polyester-based resin modified or copolymerized so as to be non-crystalline.

The content of the polyester resin relative to the entire resin composition is not particularly limited, but is, for example, 40% by mass or more and 98% by mass or less, preferably 50% by mass or more and 95% by mass or less, and more preferably 70% by mass or more and 90% by mass or less.

The Tg of the polyester resin is not particularly limited. However, it is preferable that the polyester resin be in a glass state at room temperature and change to a rubber state at a temperature at which the later-described fibers are not damaged. The Tg is, for example, 25° C. or higher and 100° C. or lower, preferably 30° C. or higher and 80° C. or lower, and more preferably 40° C. or higher and 70° C. or lower. The Tg of the polyester resin can be measured by differential scanning calorimetry (DSC) or the like.

When the polyester resin and the terpene resin dissolve in each other, the Tg of the polyester resin is higher or slightly lower than the Tg before dissolving.

### 1.1.2. Terpene Resin

Terpene resins are polymers having terpene as a constituent unit. Terpene resins encompass not only polymers generated with only a terpene as a constituent unit, but also polymers obtained by copolymerization with a petroleum-based component. Furthermore, the terpene resin may be a modified product, such as an aromatic-modified terpene resin, a terpene phenolic resin, or a hydrogenated terpene resin.

As the terpene resin, a terpene resin miscible with the above-described polyester resins is selected. Multiple terpene resins may be used. However, in this case, a terpene resin miscible with at least one of the above-described polyester resins is selected as at least one of the terpene resins.

Terpene resins are sometimes used as a tackifier and are resins to easily exert adhesiveness. The bonding material, including the resin composition, of the present embodiments does not need to contain a large amount of the terpene resin. For example, it is considered that when 1% by mass or more of the terpene resin is contained, the binding between fibers by the bonding material is strengthened, and the brittleness of the bonding material is improved.

The content of the terpene resin relative to the entire resin composition is not particularly limited, but is, for example, 1.0% by mass or more and 20.0% by mass or less, preferably 2.5% by mass or more and 17.5% by mass or less, more preferably 5.0% by mass or more and 15.0% by mass or less, and further preferably 5.0% by mass or more and 10.0% by mass or less.

The existence and mixed amount of the terpene resin can be confirmed by analysis methods such as infrared spectroscopy, gas chromatography, and thermogravimetry.

### 1.1.3. Other Components

The resin composition may include a component other than the above-described components. Examples of such a component include a compatibilizer, a colorant, an aggregation retarder, a UV absorber, a flame retardant, an anti-static agent, a charge adjuster, an organic solvent, a surfactant, a fungicide or preservative, an antioxidant, and an oxygen absorber. Also, these components may be mixed as a component of the bonding material, separately from the particles of the resin composition.

### 1.2. Properties of Bonding Material

The bonding material of the present embodiments may have powder properties. When the bonding material is powder, the particle size (average particle size based on volume) of the particles of the bonding material is preferably 50 μm or less, more preferably 30 μm or less, further preferably 25 μm or less, and particularly preferably 23 μm or less.

The lower limit of the particle size (average particle size based on volume) of the particles of the bonding material as powder is preferably 1 μm or more, more preferably 5 μm or more, and further preferably 10 μm or more.

### 1.3. Method for Producing Bonding Material

The method for producing the bonding material of the present embodiments includes a kneading step of melting and kneading the polyester resin and the terpene resin to prepare the resin composition and a crushing step of crushing the resin composition.

The resin composition is prepared by melting and kneading the polyester resin and the terpene resin. Each of the terpene resin and the polyester resin may be obtained or synthesized in any form. The resin composition can be prepared by melting and kneading the polyester resin and the terpene resin. In such a kneading step, the contents of the terpene resin and the polyester resin relative to the total amount of the resin composition can be adjusted. For example, melting and kneading may be performed such that the content of the terpene resin relative to the total amount of the resin composition is 5.0% by mass or more and 10.0% by mass or less.

When the polyester resin and the terpene resin are melted and kneaded, a resin composition including both resins dissolving in each other can be obtained. The temperature of melting and kneading can be appropriately set by adjusting the melting temperature of a thermoplastic resin, the conditions of an apparatus used for melting and kneading, and the like. Through crushing, a bonding material can be obtained in the state of a powder having a predetermined particle size.

Melting and kneading can be performed using a kneader, Banbury mixer, single-screw extruder, multi-screw extruder, double roll, triple roll, continuous kneader, continuous double roll, or the like. Crushing can be performed by a crusher such as a hammer mill, pin mill, cutter mill, pulverizer, turbo mill, disk mill, screen mill, and jet mill. These can be appropriately combined to obtain powder of the bonding material.

Also, crushing may be performed in a stepwise manner. For example, coarse crushing to achieve a particle size of substantially 1 mm may be followed by fine crushing to achieve an intended particle size. In such a case, the exemplified apparatuses can be appropriately used in each of the coarse crushing and the fine crushing. Furthermore, a freeze-crushing process can also be used for enhancing the efficiency of the crushing of the resin composition. The thus obtained powder of the resin composition can serve as a bonding material. In the crushing step, crushing is performed such that the bonding material has a volume average particle size of, for example, 0.5 μm or more and 100 μm or less and preferably 1 μm or more and 50 μm or less.

The powder of the bonding material obtained in the crushing step sometimes contains particles having various particle sizes. Therefore, a classification step of classifying particles by using a known classification device may be included as necessary. In the classification step, classification is performed such that the bonding material has a volume average particle size of, for example, 5 μm or more and 30 μm or less and preferably 5 μm or more and 23 μm or less.

The volume average particle size of the particles of the bonding material can be measured by, for example, a particle size distribution measuring device based on a laser diffraction scattering method as a measurement principle. An example of the particle size distribution measuring device is a particle size distribution meter (for example, a “Microtrac UPA” manufactured by Nikkiso Co., Ltd.) based on a dynamic light scattering method as a measurement principle.

### 2. Fiber Molded Product and Method for Producing Fiber Molded Product

The fiber molded product of the present embodiments includes the above-described bonding material and a plurality of fibers. In the fiber molded product, the plurality of fibers is bound by the bonding material. The fiber molded product denotes mainly a product formed in a sheet form. However, the form is not limited to a sheet, and may be a board, a web, or a form having unevenness. In this specification, the fiber molded product may typically be paper or nonwoven fabric. An aspect of paper includes, for example, a sheet-like product such as recording paper intended for writing or printing, wall paper, packaging paper, color paper, drawing paper, and Kent paper, molded from a raw material such as pulp or waste paper. Non-woven fabric is thicker or lower in strength than paper and includes common non-woven fabric, fiberboard, tissue paper, kitchen paper, cleaning materials, filter materials, liquid absorbing materials, sound-absorbing bodies, cushioning materials, mats, and the like.

### 2.1. Fiber

The fiber contained in the fiber molded product of the present embodiments is not particularly limited and can be a wide range of fiber materials. Examples of the fiber include naturally occurring fiber (animal fiber and vegetable fiber) and chemical fiber (organic fiber, inorganic fiber, and organic-inorganic composite fiber). Further particular examples include fibers containing cellulose, silk, wool, cotton, hemp, kenaf, flax, ramie, jute, Manila hemp, sisal, conifers, broad-leaved trees, and the like. These may be used individually or in appropriate combinations. Also, these may be used as recycled fiber subjected to purification or the like.

The raw material of the fiber is, for example, waste paper or waste cloth and includes at least one of these fibers. Also, these fibers may have various surface treatments. The material of the fiber may be a pure substance or may contain a plurality of components such as impurities, additives, and other components.

Independent single fibers constituting the fiber have an average diameter (when the cross section is not a circle, the maximum length in a direction normal to the longitudinal direction or when a circle having an area equal to the area of the cross section is assumed, the diameter (circle-equivalent diameter) of the circle) of, on average, 1 μm or more and 1000 μm or less, preferably 2 μm or more and 500 μm or less, and more preferably 3 μm or more and 200 μm or less.

The length of the fibers is not particularly limited. However, an independent single fiber has a length in the longitudinal direction of the fiber of 1 μm or more and 5 mm or less, preferably 2 μm or more and 3 mm or less, and more preferably 3 μm or more and 2 mm or less.

The bonding material contained in the fiber molded product is a bonding material for binding fibers as described above and includes the terpene resin and the polyester resin. Whether the fiber molded product includes such a bonding material can be confirmed by, for example, IR (infrared spectroscopy), NMR (nuclear magnetic resonance), MS (mass spectrometry), or various types of chromatography. Also, whether the bonding material of the present embodiments is contained in a fiber molded product can be confirmed by, for example, defibrating, crushing, or classifying the fiber molded product.

### 2.2. Method for Producing Fiber Molded Product

The method for producing the fiber molded product of the present embodiments includes a mixing step of mixing the above-described bonding material and fibers, an accumulation step of accumulating the fibers and the bonding material mixed with each other, and a binding step of binding the fibers and the bonding material of the accumulated product.

The mixing step can be performed by, for example, mixing the fibers and the bonding material in air. The accumulation step can be performed by dropping, in air, the mixture mixed in the mixing step so as to accumulate on a mesh or the like. The binding step can be performed by heating the accumulated product obtained in the accumulation step by using a hot press, a heat roller, or the like to melt the bonding material.

The method for producing the fiber molded product of the present embodiments may include, as necessary, at least one step selected from the group consisting of a cutting step of cutting a raw material such as pulp sheet or waste paper in air, a defibration step of breaking up, in air, the raw material into a fibrous form, a classification step of classifying, in air, impurities and fibers shortened by defibration, from the defibrated product, a sorting step of sorting, in air from the defibrated product, long fibers (continuous fibers) and non-defibrated fiber pieces which have not been sufficiently defibrated, a pressurization step of pressurizing at least one of the accumulated product and the fiber molded product, a cutting step of cutting the fiber molded product, and a packaging step of packaging the fiber molded product.

In the fiber molded product, the mixing ratio of the bonding material to the above-described fibers can be appropriately adjusted depending on, for example, the strength or use of a fiber molded product to be produced. When the fiber molded product is used for office applications such as copy paper, the ratio of the bonding material to the fibers is 5% by mass or more and 70% by mass or less.

### 3. Relationship Between Bulk Physical Properties of Bonding Material and Mechanical Properties of Fiber Molded Product

In general, the tear strength of paper is a mechanical property exhibited as a result of each structure of the paper influencing other structures and does not necessarily exhibit a good correlation with the mechanical properties of each of the structures of paper. However, as a result of research by the inventor, it was found that when the above-described fiber molded product is dry paper, the tear index of the paper exhibits a good correlation with the Izod impact strength of a bulk specimen of the bonding material.

Izod impact strength is measured in accordance with Japanese Industrial Standard (JIS) K 7110:1999 “Plastics—Determination of Izod impact strength” and obtained using an unnotched specimen. On the other hand, the tear index is measured in accordance with Japanese Industrial Standard (JIS) P8116 “Paper—Determination of tear strength—Elmendorf tearing tester method”.

As demonstrated in Examples, it is known that when the Izod impact strength (unnotched) is 3 kJ/m² or more, the tear index is 7.0 mN·m²/g or more. However, as a result of various reviews, changing the type of resin does not necessarily improve the tear index. At this point in time, however, what has strong influence is unknown. Under such circumstances, it was found that the improvement in Izod impact strength by blending terpene resin with resin can improve the tear index of paper more reliably than the improvement in Izod impact strength by resin alone.

The terpene resin has a property of completely dissolving in each other with the bonding material, and terpene resin itself is rich in elasticity and malleability. It is estimated that when such a resin is blended, the impact resistance of the bonding material can be improved.

Also, as demonstrated in Examples, it was found that the amount of terpene resin mixed has an appropriate range. When the amount of terpene resin mixed is small, the impact resistance of the bonding material is insufficient, and the tear index of paper does not exhibit a sufficiently high value. When the amount of terpene resin mixed is excessively large, the impact resistance is also insufficient, with the result that the tear index of paper tends to fail to reach a sufficiently high value.

### 4. Examples and Comparative Examples

Hereinafter, the present disclosure will be further described by illustrating Examples and Comparative Examples. However, the present disclosure is not limited to the following examples in any way.

### 4.1. Production of Bonding Material

As the polyester resin, ACT-6202 (manufactured by DIC Corporation) was used. As the terpene resin, YS Resin PX-1150 (manufactured by Yasuhara Chemical Co., Ltd.) was used.

A bonding material of Example 1 was produced in the following manner. In a hopper, 20 kg of polyester resin and 0.5 kg of terpene resin were mixed. Thereafter, the mixture was poured into a small twin-screw extruder, and melted and kneaded at 100° C. to 140° C. The resultant product was extruded through a die and cut into lengths of substantially 5 mm to obtain pellets. The obtained pellets were subjected to a coarse crushing treatment by a pin mill into a granular form and then poured into a jet mill to obtain powder having a particle size range of 1 μm to 50 μm. The powder obtained by the jet mill was classified by a classification device to obtain, as the bonding material of Example 1, powder constituted by particles having a volume-based average particle size of 12 μm and a particle size of 5 μm to 23 μm.

The bonding materials of Examples 1 to 7 and Comparative Example 1 were prepared by adjusting the amounts of resins according to the values in Table 1 and by processing the resins in the same manner as in Example 1 to obtain, as a bonding material of each example, powder constituted by particles having an average particle size of 12 μm and a particle size of 5 μm to 23 μm.

TABLE 1

| | Terpene | Polyester | Izod impact | Tear index |
|---|---|---|---|---|
| | resin | resin | strength | JIS P 8116 |
| | (mass %) | (mass %) | JIS K7110 (kJ/m²) | (mN · m²/g) |
| Example 1 | 2.5 | 97.5 | 2.6 | 6.4 |
| Example 2 | 5.0 | 95.0 | 3.0 | 7.2 |
| Example 3 | 7.5 | 92.5 | 4.1 | 7.9 |
| Example 4 | 10.0 | 90.0 | 3.0 | 7.5 |
| Example 5 | 12.5 | 87.5 | 2.7 | 6.5 |
| Example 6 | 15.0 | 85.0 | 2.6 | 6.4 |
| Example 7 | 17.5 | 82.5 | 2.5 | 6.0 |
| Comparative | 0.0 | 100.0 | 1.6 | 6.0 |
| Example 1 | | | | |

### 4.2. Izod Impact Test

Izod impact strength was measured in accordance with Japanese Industrial Standard (JIS) K 7110:1999 “Plastics—Determination of Izod impact strength”. The detailed conditions of the test are as follows.

A specimen was unnotched and had a size of 80 mm×10 mm×8 mm. The specimen was prepared through injection molding by attaching a mold for strip specimens (unnotched) to a TNX50R injection molder (manufactured by Nissei Plastic Industrial Co., Ltd.). In the Izod impact test, a No. 258 impact tester (manufactured by Yasuda Seiki Seisakusho, Ltd.) was used. According to the standard of each resin, measurement was performed twice, and the average value thereof was adopted. The measurement environment was 25° C./50% RH.

### 4.3. Tear Index (Elmendorf Tearing Tester Method)

The bonding material of each Example was mounted on a PaperLab A-8000 device dedicated for testing manufactured by Seiko Epson Corporation to manufacture paper at a set basis weight of 90 g/m². A PPC paper manufactured by Seiko Epson Corporation was used as a raw paper to obtain the fiber molded product of each example.

The tear index of the fiber molded product of each example was measured in accordance with Japanese Industrial Standard (JIS) P8116 “Paper—Determination of tear strength—Elmendorf tearing tester method”. The specimen had a size of 63 mm×76 mm, and the tearing length of the specimen after being notched was set to be 43 mm. Two stacked specimens were subjected to a test, and the test was repeated ten times for each standard. Although the test was performed in both the machine direction and the short grain, the measuring result in the machine direction was adopted and evaluated. In the machine direction test, no abnormal tearing was observed, and skinning did not occur. The test environment was 23° C./50% RH.

### 4.4. Evaluation Results

From the results of the Izod impact test, it was found that as the blend amount of the terpene resin increases, the Izod impact strength tends to increase to 7.5% by mass and decreases thereafter so as to have a peak. In addition, the tear index also has a peak at a blend amount of 7.5% by mass. This result demonstrated that there is a tendency for the Izod impact strength to be substantially proportional to the tear index. Although the reason for this tendency is not determined, it is postulated that the tear index of recycled paper is influenced by the bonding strength of the bonding material more than by the strength of the fibers and that the tear index depends on the impact resistance of the bonding material more than on the bonding strength at the adhesive surface between the bonding material and the fibers.

A large force such as a shearing force is instantaneously added in a tearing test. Therefore, it is considered that an important material quality for withstanding such a force may be impact resistance. The reason why the impact resistance has a peak with respect to the blend amount has not been determined. Although the impact resistance was not significantly lost, even when the added amount of the terpene resin increases, the tear index of recycled paper tended to decrease with respect to the blend amount. In view of these results, it is considered that the tear index can be effectively maintained at a high level when the mixed amount of the terpene resin is 5% by mass or more and 10% by mass or less.

The present disclosure is not limited to the above-described embodiments and can be variously modified. For example, the present disclosure encompasses substantially the same structure as the structure described in the embodiments (a structure having the same function, method, and result, or a structure having the same object and effect). Also, the present disclosure encompasses the structure described in the embodiments of which a non-essential structure is replaced. In addition, the present disclosure encompasses a structure having the same function and effect as the structure described in the embodiments or a structure capable of achieving the same object. Furthermore, the present disclosure encompasses the structure described in the embodiments to which a known art is added.

What is claimed is:

1. A method for producing a bonding material, the method comprising:
a kneading step of melting and kneading a polyester resin and a terpene resin to prepare a resin composition; and
a crushing step of crushing the resin composition.

2. The method for producing a bonding material according to claim 1, wherein
the kneading step includes performing the melting and the kneading such that a content of the terpene resin relative to a total amount of the resin composition is 5% by mass or more and 10% by mass or less.

3. The method for producing a bonding material according to claim 1, wherein
the crushing step includes crushing the resin composition so as to have a volume average particle size of 1 μm or more and 50 μm or less.

4. The method for producing a bonding material according to claim 1, further comprising
a classification step of classifying the bonding material so that a volume average particle size of the bonding material is 5 μm or more and 23 μm or less.

5. A bonding material comprising
a resin composition containing
a polyester resin and
a terpene resin.

6. The bonding material according to claim 5, wherein
a content of the terpene resin relative to a total amount of the resin composition is 5% by mass or more and 10% by mass or less.

7. The bonding material according to claim 5, wherein
the bonding material is powder and has a volume average particle size of 5 μm or more and 23 μm or less.

8. A fiber molded product comprising:
the bonding material according to claim 5; and
a plurality of fibers, wherein
the plurality of fibers is bound by the bonding material.

9. A method for producing a fiber molded product, the method comprising:
a mixing step of mixing the bonding material according to claim 5 and fibers;
an accumulation step of accumulating the fibers and the bonding material mixed together, and
a binding step of binding the fibers and the bonding material of the accumulated product.
